(19) United States
(12) Patent Application Publication
(10) Pub. No.: US 2016/0077667 A1
(43) Pub. Date: Mar. 17, 2016

(54) Scan method for a touch panel and touch device

(71) Applicant: ELAN MICROELECTRONIC CORPORATION, Hsinchu (TW)

(72) Inventors: CHIA-CHANG CHIANG, Hsinchu County (TW); YAO-CHIN TSENG, Tainan City (TW)

(73) Assignee: ELAN MICROELECTRONIC CORPORATION, Hsinchu County (TW)

(21) Appl. No.: 14/601,430

(22) Filed: Jan. 21, 2015

(30) Foreign Application Priority Data
Sep. 12, 2014 (TW) 103131482

(51) Int. Cl. G06F 3/041

(52) U.S. Cl. CPC G06F 3/0418

(57) ABSTRACT

The present invention relates to a scan method for a touch panel and a touch device. It operates two different Analog-to-Digital Converter calibrations to have different baselines and thresholds corresponding respectively to a cursory scan mode and a fine scan mode. In cursory scan mode, multiple traces are driven simultaneously and the signals from the traces are received simultaneously to enlarge the sensing value so that a touch object with a lower sensing signal is also detected. Further, the cursory scan mode with less electricity cost is used to first determine whether touch objects exists. When the touch objects do exist, the fine scan mode with more electricity cost is then operated. Therefore, the present invention can further reduce the electricity waste.

### CROSS-REFERENCE TO RELATED APPLICATIONS

This application is based upon and claims priority under 35 U.S.C. 119 from Taiwan Patent Application No. 103131482 filed on Sep. 12, 2014, which is hereby specifically incorporated herein by this reference thereto.

### BACKGROUND OF THE INVENTION

1. Field of the Invention

The present invention is related to a scan method for a touch panel, especially to a method to scan the touch object on the touch panel of electronic device.

2. Description of the Prior Arts

Touch panel is common used in high-tech product that is used as input device in the electronic device. There are multiple traces in the touch panel that the traces are driven by a driving unit controlled by a processor, and the sensing signals of the traces are received by a receiving unit, whether touch object exist or not is determined based on the sensing signal and the coordinate of the touch object is further determined.

With reference of FIG. 9, to ensure the accuracy of sensing frame, the multiple sub-periods are included in each scanning period of the conventional scan method in fine scan mode; scanning each trace in sequence at each sub-period to obtain a sub-sensing frame, obtaining multiple sub-sensing frames (F1˜F32) after during all the sub-period; calculating multiple sub-sensing frames (F1˜F32) to obtain an effective sensing frame F; determining whether touch object exists by the effective sensing frame F, if touch object do exist, then determining and returning the coordinate of the touch object; if no touch object exist, then entering the sleep mode from the fine scan mode wherein no action of the driving unit and receiving unit and re-starting the scanning when next scanning period begin. Since the sleep mode of the conventional scan method is setting to save electricity, but actually it still waste electricity.

Taking touch panel with 24 traces and 2 receiving circuits with scanning parameter: frame rate 100 Hz (scanning period 10 ms), the scanning time of each trace 10 μs, one scanning period had 32 sub-scanning period as an example: Since 24 traces of touch panel are connected respectively by two receiving circuit that the sensing signals of the 12 traces are received simultaneously by the receiving circuit, each sub-period is 120 μs (10 μs×(24/2)=120 μs) and acquiring 32 sub-sensing frame spends 3840 μs, sleep modes spends 96160 μs so that the period of fine scan mode is more than one-third of the total time of the scanning period. Driving unit and receiving unit are in the active status in the fine scan mode but driving unit and receiving unit are no action in the sleep mode so that the electricity cost in the fine scan mode is bigger than sleep mode in each scanning period.

However, from the point of view of the usability of electronic device, the period that user doesn't touch the touch panel is longer than the period of touching the touch panel, taking smart phone as an example, the period of user reading the information on the touch panel is longer than the period of touching the touch panel; and taking touchpad on the notebook that is used as input device as an example, user usually use keyboard as input device and touchpad is usually not touched when using computer. When the touch device is not touched for a long time, the conventional scan method still detect the coordinate of the touch object by waking up the touch device in regular period and entering the fine scan mode with high electricity cost, the conventional scan method waste electricity since no touch object exist.

Furthermore, the conventional scan method drives each trace in sequence by the driving unit and receives the sensing signal of each trace in sequence by the receiving unit, when user touch the touch panel with glove, the sensing signal is lower and the touch object existence can't be determined correctly and the coordinate of the touch object also can't be determined in further, it is inconvenient when using touch panel.

To overcome the shortcomings, the present invention provides a scan method with less electricity cost and high sensing value to mitigate or obviate the aforementioned problems.

### SUMMARY OF THE INVENTION

An objective of the present invention is to provide a scan method with less electricity cost and high sensing values to effectively overcome the shortcoming of a conventional scan method with high electricity cost and low sensing values.

To achieve the foregoing objective, the scan method for a touch panel with low electricity cost has steps of:

executing a first Analog-to-Digital Converter calibration (ADC calibration) for a cursory scan mode to get a first baseline, and setting a first threshold based on the first baseline;

executing a second ADC calibration for a fine scan mode to get a second baseline, and setting a second threshold based on the second baseline;

entering in the cursory mode or the fine scan mode;

in the cursory mode, driving i traces and receiving a first sensing signal of j traces simultaneously and comparing the first sensing signal with the first threshold to determine whether at least one touch object exists; if the at least one touch object exists, then entering the fine scan mode, wherein “i” and “j” are positive integers that are bigger than one;

in the fine scan mode, driving multiple first groups of the traces in sequence, wherein each first group of the traces includes k traces; receiving a second sensing signal from multiple second groups of the traces, wherein each second group of the traces includes h traces; and determining a coordinate of the at least one touch object by the second sensing signal and the second threshold, “k” is a positive integer that is smaller than “i” but is bigger than one, and “h” is a positive integer that is bigger than or equal to one.

The scan method in accordance with the present invention defaults the baselines and the thresholds respectively corresponding to the cursory scan mode and the fine scan mode. In cursory scan mode, multiple traces are driven simultaneously and the signals from the traces are received simultaneously to save electricity than the fine scan mode that the traces are driven in sequence. The cursory scan mode is used to first determine whether a touch objects exists. When the touch object do exist, the fine scan mode is then operated to determine the coordinate of the touch object. Therefore, the present invention can reduce the electricity waste.

Furthermore, since multiple traces are driven simultaneously and the signals from the traces are received simultaneously in cursory mode, the sensing value is enlarged so that a touch object with a lower sensing signal such as the user touch the panel through a glove can be also detected. In fine scan mode, if “k” and “h” are both bigger than one, the sensing value is also enlarged to determine the coordinate of the touch object with a lower sensing signal.

The present invention also provides a touch device including:

a touch panel having p traces;

a controller connecting to the touch panel and having
a driving unit;
a receiving unit having the at least one sub-receiving unit to receive sensing signals simultaneously;
a memory unit saving the first ADC calibration, the second ADC calibration, the cursory scan mode and the fine scan mode; and
a processor executing following steps when the touch device is started:

controlling the driving unit to execute the first ADC calibration, obtaining the first baseline in the cursory scan mode by the at least one sub-receiving unit, setting the first threshold based on the first baseline, and storing the first baseline and the first threshold in the memory unit;

controlling the driving unit to execute the second ADC calibration, obtaining the second baseline in the fine scan mode by the at least one sub-receiving unit, setting the second threshold based on the second baseline, and storing the second baseline and the second threshold in the memory unit.

entering in the cursory mode or the fine scan mode:

receiving a first sensing signal of the j traces simultaneously by the at least one sub-receiving unit in the cursory mode and determining whether at least one touch object exists by the first sensing signal, wherein “j” is a positive integer that is bigger than one;

receiving a second sensing signal of the h traces simultaneously by the at least one sub-receiving unit in the fine scan mode and determining the coordinate of the at least one touch object by the at least one second sensing signal, wherein “h” is a positive integer that is bigger than or equal to one.

The foregoing touch device save electricity by the cursory scan mode and use the at least one sub-receiving unit to receive sensing signal simultaneously.

Also, the present invention provides another touch device including:

a touch panel having p traces;

a controller which connecting to the touch panel and having
a driving unit;
a receiving unit having the at least one sub-receiving unit to receive sensing signal simultaneously;
a processor; and
a detecting circuit connecting to the touch panel, the controller and having:
   a memory having a first register and a second register, saving the first baseline by the first register and saving the first threshold by the second register,
   an ADC connecting the p traces of the touch panel to one of the inputs to receive the sensing signals of the p traces and to convert the sensing signals to the corresponding sensing value simultaneously; and
   a comparator having a first input connecting an output of the ADC to acquire the sensing values, a second input of the comparator connecting to the second register of the memory to acquire the first threshold, an output of the comparator connecting to the processor, wherein the comparator compares the sensing values with the first threshold to determine whether the processor should be waked up.

Based on the foregoing touch device, the sensing signals are received and existence of the touch object is determined by the outer detecting circuit in cursory sensing mode and the non-operating time of the receiving unit and the processor of the controller are extend to save electricity more efficiently. Moreover, the present invention provides a scan method for increasing sensing value to the touch panel including following steps:

executing a first ADC calibration to get a first baseline and setting a first threshold based on the first baseline;

driving the i trace and receiving the first sensing signal of the j trace simultaneously, wherein “i” and “j” are positive integers that are bigger than one;

comparing the first sensing signal and the first threshold to determine whether at least one touch object exists;

determining the coordinates of the touch object when the at least one touch object do exist, and then going back to the step of driving the i trace.

Based on the foregoing scan method, multiple traces are driven simultaneously and the signals from the traces are received simultaneously to enlarge the sensing value so that a touch object with a lower sensing signal can be detected.

In conclusion, using the cursory scan mode to determine the existence of the touch object, touch panel is scanned with less electricity cost in general condition. Driving multiple traces simultaneously and receiving the signals from the traces simultaneously enlarge the sensing value to detect the touch object with lower sensing signal. Therefore, the present invention reduces the electricity waste and enlarges the sensing value.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a touch device in accordance with the present invention;

FIG. 2 is a flow chart of a first embodiment of a scan method in accordance with the present invention;

FIG. 3 is another flow chart of a first embodiment of a scan method in accordance with the present invention;

FIG. 4 is a Sequence Diagram of a scan sequence of the touch device in FIG. 1, shown in no touch object condition;

FIG. 5 is a flow chart of a second embodiment of a scan method in accordance with the present invention;

FIG. 6 is a block diagram of the second embodiment of a touch device in accordance with the present invention;

FIG. 7 is a circuit diagram of part of the component in the second embodiment of the touch device in FIG. 6;

FIG. 8 is a flow chart of a third embodiment of a scan method in accordance with the present invention; and

FIG. 9 is a sequence diagram of a scan sequence of a touch device in accordance with the prior art, shown in no touch object condition.

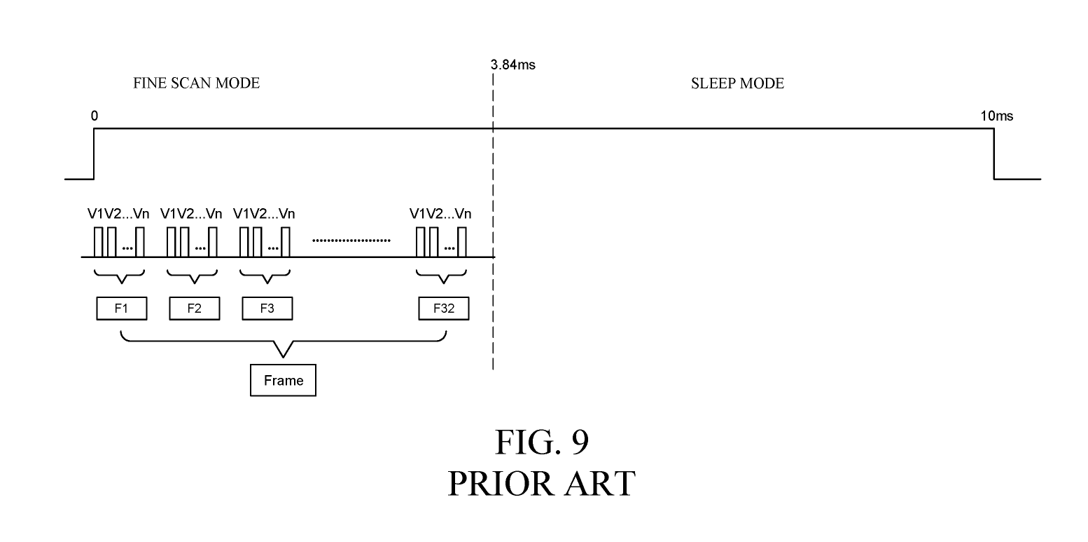

### DETAILED DESCRIPTION OF THE PREFERRED EMBODIMENTS

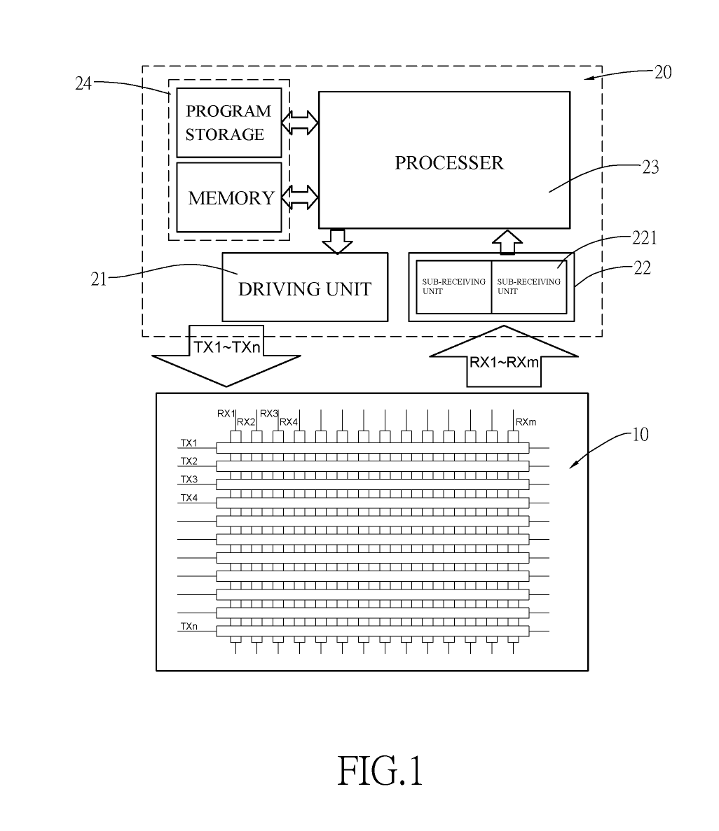

With reference to FIG. 1, a first embodiment of the touch device in accordance with the present invention comprises a touch panel 10 and a controller 20.

The touch panel 10 has p traces including multiple first-axis traces and second-axis traces across each other. Taking self-capacitance scanning as an example, the p traces are both the driving lines and the receiving lines, taking mutual-capacitance scanning as shown in FIG. 1 as an example, the first-axis traces TX1˜TXn are the driving lines and the second-axis traces RX1˜RXm are the receiving lines.

The controller 20 connects to the touch panel 10 and includes a driving unit 21, a receiving unit 22, a processor 23 and a memory unit 24. The processor 23 controls the driving unit 21 to drive the driving lines of the touch panel 10. The receiving unit 22 receives the sensing signal from the receiving line of the touch panel 10 and then the processor 23 further deals with the sensing signal. In the first embodiment, the first-axis trace TX1˜TXn are driven by the driving unit 21 and the sensing signal of the second-axis trace RX1˜RXm are received by the receiving unit 22.

The receiving unit 22 has at least one sub-receiving unit 221. One sub-receiving unit 21 can receive the sensing signals of the at least two traces of the touch panel 10 simultaneously; or multiple sub-receiving units 221 respectively receive the sensing signals of the traces of the touch panel 10 wherein each sub-receiving unit 221 receives the sensing signals of the at least two traces of the touch panel 10.

The memory unit 24 comprises a program storage and a memory. The storage stores a process (algorithm) and steps executed by the processor. The memory stores a specific value and a result from executing process by the processor such as the baseline, the threshold and the sensing signal.

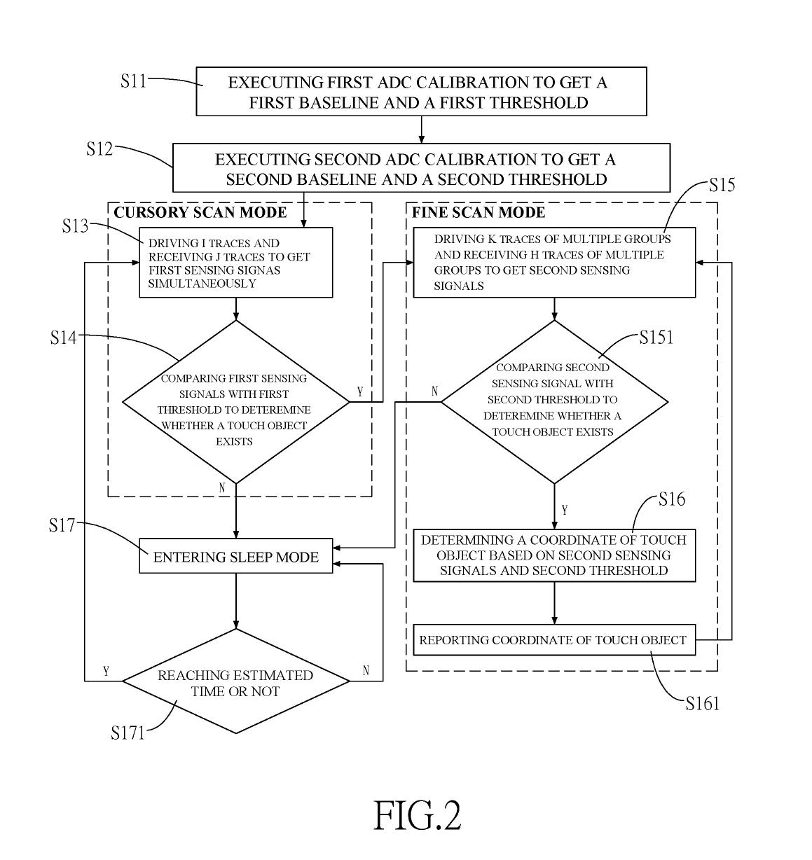

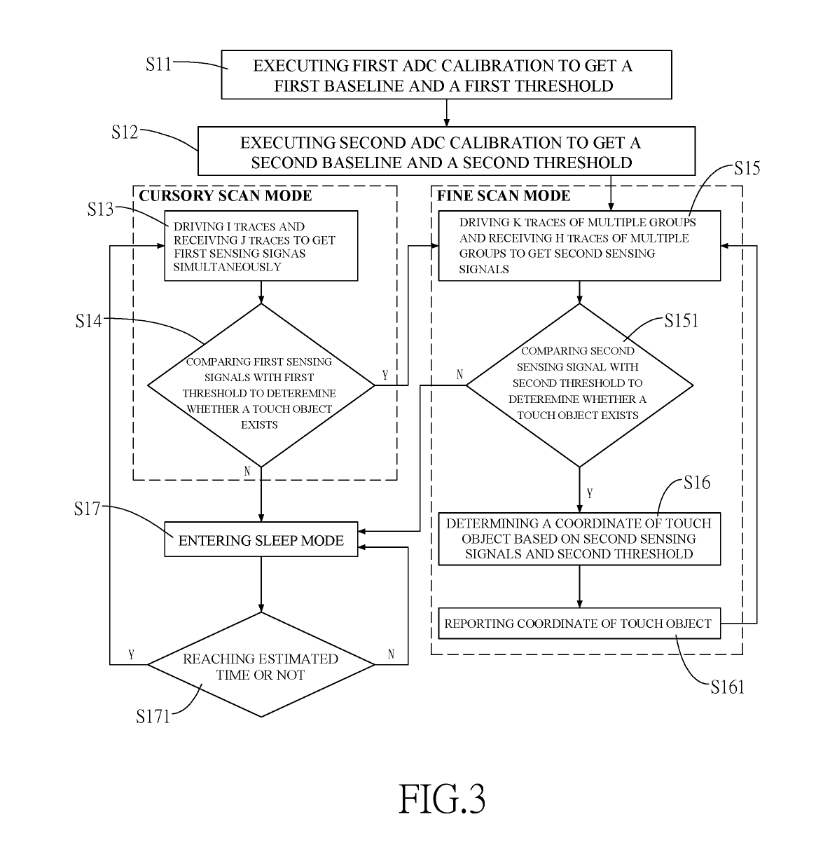

Using the touch device shown in FIG. 1 as an example, the first embodiment of a scan method in accordance with the present invention is shown in FIGS. 2 and 3. A first ADC calibration, a second ADC calibration, a cursory scan mode, a fine scan mode and a sleep mode are stored in the memory unit 24. The scan method comprises following steps:

Executing the first ADC calibration (S11): The first ADC calibration is executed by the processor 23 to obtain a first baseline in the cursory scan mode, and a first threshold is set based on the first baseline. Especially the i traces are driven and the sensing signals of the j traces are received simultaneously in cursory mode. The “i” and “j” are both positive integers that are larger than one. Taking self-capacitance scanning as an example, the i traces and the j traces are the same traces because the controller 20 drives and receives the same traces simultaneously. The i traces are simultaneously driven by the driving unit 21, and the sensing signal of the i traces are simultaneously received by the receiving unit 22. Taking mutual-capacitance scanning as an example (shown in FIG. 1), the i traces are included in the first-axis traces TX1˜TXn and the j traces are included in the second-axis traces RX1˜RXm, The i traces are driven simultaneously by the driving unit 21, and the sensing signal of the j traces are received by the receiving unit 22;

Executing the second ADC calibration (S12): The second ADC calibration is executed by the processor 23 to obtain a second baseline in the fine scan mode and a second threshold is set based on the second baseline. Especially, in the fine scan mode, multiple first groups of the traces are driven in sequence, and the sensing signals from multiple second groups of the traces are received in sequence. Each first group of the traces includes k traces. Each second group of the traces includes h traces. The “k” is a positive integer that is smaller than i but is bigger than one, and the “h” is a positive integer that is bigger than or equal to one. Taking self-capacitance scanning as an example, the k traces of the first groups of the traces and the h traces of the second groups of the traces are the same traces, because the k traces of each group of the traces are driven by the driving unit 21 and the sensing signal of the k traces of each group of the traces are received by the receiving unit 22. Taking mutual-capacitance scanning as an example (shown as FIG. 1), the k traces of the first groups of the traces are included in the first-axis traces TX1˜TXn and the h traces of second groups of the traces are included in the second-axis traces RX1˜RXm. The k traces of the first groups of the first-axis traces are driven in sequence by the driving unit 21. After the k traces of each first group of the first-axis traces are driven, the sensing signal of the h traces of each second group of the second-axis traces are received in sequence by the sub-receiving unit 221 of the receiving unit 22 until the sensing signals of all of the second axis traces are received.

Then the cursory mode is entered first (as shown in FIG. 2) or the fine scan mode is entered first (as shown in FIG. 3). However, no matter which one is entered first, the execution steps in cursory scan mode or the fine scan mode are not changed; Entering the cursory scan mode: The i traces are driven by the driving unit 21, and the first sensing signals of the j traces are received simultaneously (S13) by the receiving unit 22. The first sensing signals are compared with the first threshold to determine whether at least one touch objects exist (S14); if the at least one touch object exists, the fine scan mode is entered. Taking self-capacitance scanning as an example, the i traces are driven simultaneously by the driving unit 21 and the first sensing signals of the i traces are received simultaneously by the receiving unit 22. Taking mutual-capacitance scanning as an example, the i traces are driven simultaneously by the driving unit 21 and the first sensing signals of the j traces are received by the receiving unit 22.

Entering the fine scan mode: The first groups of the traces are driven in sequence by the driving unit 22, and the second sensing signals of the second groups of the traces are received by the receiving unit 22 (S15). A coordinate of the touch object are determined by the second sensing signals and the second threshold (S16). In a preferred embodiment, the second sensing signals are first used to determine whether the touch objects exist (S151); if the touch objects exist, then the coordinate of the touch object are further determined (S161) and then return to the step S15. taking self-capacitance scanning as an example, driving the k traces of the first groups of the traces are driven in sequence by the driving unit 21, and the second sensing signals of the k traces of the corresponding groups of the traces are received in sequence by the receiving unit 22 until the second sensing signals of all of the traces are received. The receiving unit 22 can receive the second sensing signals of the k traces of each first group of the traces simultaneously. Taking mutual-capacitance scanning as an example, the k traces of each first group of the first-axis traces are driven simultaneously every time by the driving unit 21 for each time, and the sensing signals of all the second-axis traces corresponding to the driven first-axis traces are received by the receiving unit 22 until all of the first-axis traces are driven. When “h” is equal to one, the second sensing signals of the second-axis traces are driven in sequence by the receiving unit 22. When “h” is bigger than 1, the second sensing signals of the h traces of each second group of the second-axis traces are received simultaneously by the receiving unit 22.

Based on the foregoing touch device and scan method of the present invention, the first ADC calibration and the second ADC calibration are executed separately to obtain the baselines and the thresholds respectively corresponding to the cursory scan mode and the fine scan mode. The cursory mode or the fine scan mode is entered. Driving the i traces and receiving the sensing signals of the j traces simultaneously in the cursory scan mode can quickly determine whether touch object exists. When the touch object do exist, the fine scan mode is then operated to determine the coordinate of the touch object. Therefore, entering in the fine scan mode with high electricity cost is not necessary at each scanning period and so that the electricity waste is reduced when no touch object exists. Since multiple traces are driven simultaneously and the sensing signals of the traces are received and summed up simultaneously to enlarge the sensing value in the cursory scan mode, the summed sensing signals can become effect sensing signals with high sensing values and high identification. Therefore, the touch object can also be detected when a touch object is with the lower sensing signal such as the user touch the panel through a glove.

Moreover, executing mutual-capacitance scanning in the fine scan mode can acquire the all points sensing frame and identify the exact coordinate of the touch object when “k” and “h” are equal to one. When “k” is bigger than or equal to one but smaller than “n” and “h” is bigger than one but smaller than m, executing mutual-capacitance scanning in the fine scan mode can enlarge the sensing signals and acquire the sensing frame to identify the rough coordinate of the touch object, which is applied to the case such as the user touch the panel through a glove. Executing self-capacitance scanning in the fine scan mode can identify the exact coordinate of the touch object when “k” is equal to one. When “k” is bigger than one and the touch panel has twenty-four traces, six first groups of traces of touch panel are determined in the fine scan mode if “k” is equal to four. For each time, four traces of each group of the traces are driven and the sensing signals of the four traces are received and summed up to enlarge the sensing signals so that the coordinate of the touch object can be determined by summed sensing signals when the traces are with the lower sensing signals such as the user touch the panel through a glove. Furthermore, taking the touch panel with twenty-four traces as an example, the traces can be overlapped in different groups of the traces when “k” is also equal to four. Therefore, more than six groups of traces are divided. If each adjacent group has two overlapped traces, twenty-four traces can be divided to eleven groups to increase the sensing accuracy.

The scan method of the present invention may further have the following steps:

Entering the sleep mode (S17): the sleep mode is entered by the processor 23 when no touch object is determined by the processor 23 in a first estimated time in the cursory scan mode or the fine scan mode. In the sleep mode, the following steps are executed by the processor 23 to determine whether the period of the sleep mode has reached the second estimated time (171). If the period of the sleep mode has reached the second estimated time, then return to the cursory scan mode.

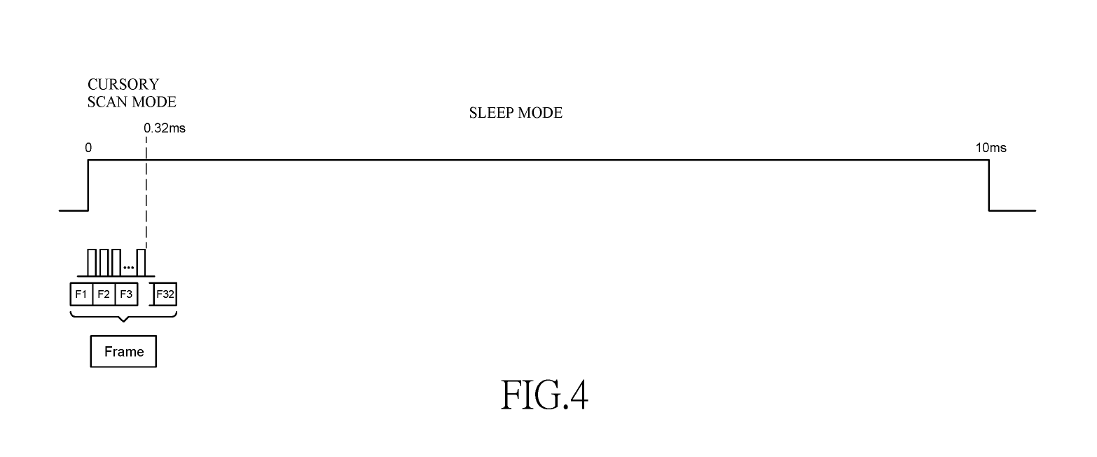

The electricity waste can be reduced efficiently by the setting of the sleep mode when no touch object exists. In one embodiment, the touch panel has twenty-four traces and two sub-receiving units 221 as shown in FIG. 4 with the scanning parameter: the frame rate 100 Hz (scanning period 10 ms), the scanning time of each traces 10 μs, one scanning period had thirty-two sub-scanning periods. Since twelve of the twenty-four traces of the touch panel are connected respectively to the two sub-receiving units 221 and the sensing signals of the corresponding twelve traces are received simultaneously by each sub-receiving unit 221, each sub-scanning period is 10 μs. Therefore, only 320 μs spent to acquire thirty-two sub-sensing frames, 9680 μs is spent for the sleep modes so that the period of cursory scan mode is less than one-tenth of the total time of the scanning period. When the electricity cost in cursory scan mode is 5400 μA and the electricity cost in sleep mode is 7.5 μA, the average electricity cost of the present invention is 180.1 μA when no touch object exists((320×5400+9680×7.5)/10000=180.06). When no touch object exists, the average electricity cost of the present invention (180.1 μA) is less than one-tenth to the average electricity cost of the prior art (2078 μA). Thus, the present invention can further reduce electricity in further when no touch object exists.

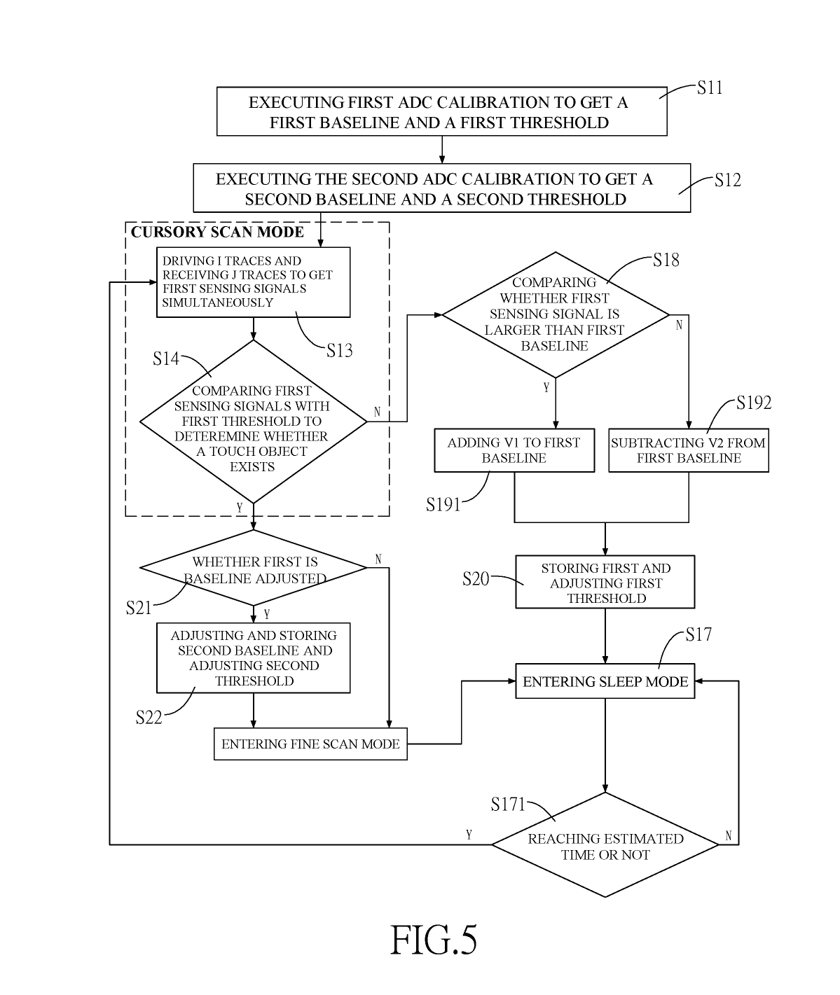

With the reference of FIG. 5, the steps of a second embodiment of the scan method in accordance with the present invention S11˜S14 is the same with the steps S11˜S14 in the flow chart shown as FIG. 2 and adds steps for adjusting the baseline. The step S14 includes the following steps: Adjusting the first baseline and the first threshold: The first baseline and the first threshold are further compared when no touch object is determined by the processor 23 (S18). Based on the comparison result, the first baseline or the first threshold is adjusted and the adjusted first baseline or the adjusted first threshold is stored back to the memory unit 24; or the first baseline is adjusted first, and then the first threshold is adjusted based on the adjusted first baseline (S20). The adjusted first threshold is stored back to the memory unit 24. Then the sleep mode S17 is entered and the step S171 is executed. When the first sensing signal is bigger than the first baseline, a V1 value is added to the first baseline (S191). When the first sensing signal is smaller than the first baseline, a V2 value is subtracted from the first baseline (S192). V1 and V2 can be equal or non-equal;

Adjusting the second baseline and the second threshold: Before the second sensing signals are acquired by the processor 23 in the fine scan mode, whether the first baseline is adjusted or not is determined (S21). If the first baseline has adjusted, the second baseline or the second threshold are adjusted based on the adjusted first baseline. Then the adjusted second baseline or the adjusted second threshold are stored back to the memory unit 24; or the second baseline is adjusted first, the second threshold is adjusted based on the adjusted second baseline. Then the adjusted second baseline or the adjusted second threshold are stored back to the memory unit 24 (S22). When a V1 value is added to the first baseline, a W1 value is added to the second baseline. When a V2 value is subtracted from the first baseline, a W2 value is subtracted from the second baseline. W1 and W2 can be equal or non-equal. Then the fine scan mode is entered.

If the touch object does not exist on the touch device for a long time, the baseline and the threshold determined by the ADC calibration when the touch device first started is different from the environment condition when the touch device used later. Therefore, adjusting the baseline and the threshold by the foregoing steps allows the baseline and the threshold corresponding to the instant environment and the sensing sensitivity of touching is increased.

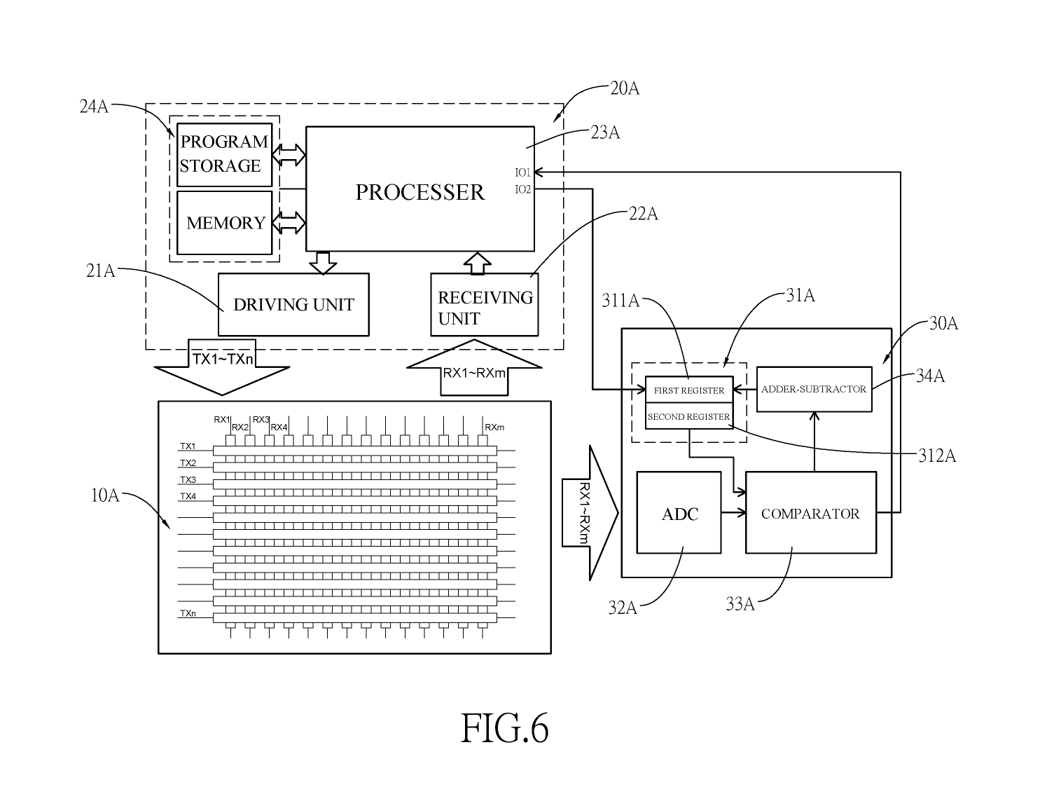

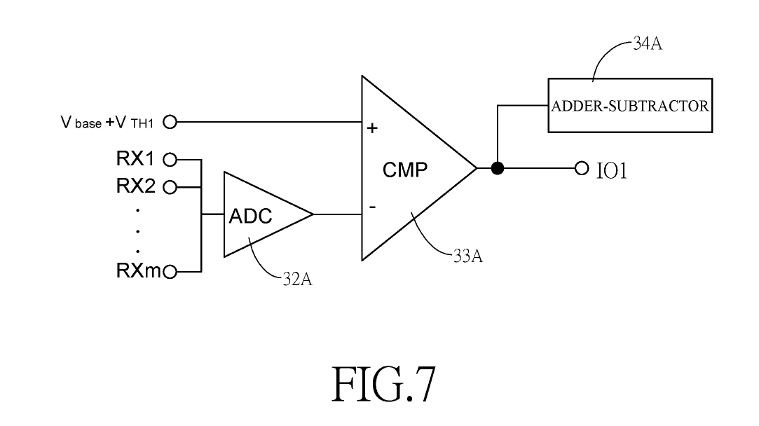

With the reference of FIGS. 6 and 7, the second embodiment of the touch device in accordance with the present invention has a touch panel 10A, a controller 20A and a detecting circuit 30A. The touch panel 10A and the controller 20A is the same with that of the first embodiment as shown in FIG. 1. The touch panel 10A has p traces and the controller 20A has a driving unit 21A, a receiving unit 22A, a processor 23A, and a memory unit 24A as well.

The detecting circuit 30A connects to the touch panel 10A and the controller 20A includes a memory 31A, an analog to digital converter (ADC) 32A and a comparator 33A. The memory 31A sets a first register 311A and a second register 312A. The traces of the touch panel 10A are all connected to one of the inputs of the analog to digital converter (ADC) 32A that sensing signals of the traces are received simultaneously and the sensing signals are converted to the corresponding sensing value by the ADC. One of the inputs of the comparator 33A is connected to the one of the outputs of the ADC 32A, and another one of the inputs of the comparator 33A is connected to the second register 312A of the memory 31A. One of the outputs of the comparator 33A is connected to the processor 23A.

The detecting circuit further comprises an adder-subtractor 34A. One of the inputs of the adder-subtractor 34A is connected to the output of the comparator 33A, and another one of the outputs of the comparator 34A is connected to the first register 311A of the memory 31A.

With the reference of FIGS. 2, 5 and 7, the executing steps of the foregoing scan method have following differences when the second embodiment of the touch device in accordance with the present invention is used:

The first baseline is stored to the first register 311A of the memory 31A and the first threshold is stored to the second register 312A of the memory 31A of the detecting circuit 30A when the first ADC calibration is executed by the processor 23 (S11);

When the steps is executed by the processor 23 in the cursory mode, the first sensing signals of the j traces are received simultaneously by the ADC 32A (S13). The first sensing signal and the first threshold is compared to determine whether touch objects exists by the comparator 33A(S14). Taking self-capacitance scanning as an example, the first sensing signals of the i traces are received simultaneously by the ADC 32A; taking mutual-capacitance scanning as an example, the first sensing signals of the j traces are received simultaneously by the ADC 32A;

The comparator 33A compares the first sensing signal and the first threshold to determine whether touch objects exists and judge the processor 23 waked up or not. If the touch object exists, the processor 23A is woken up and the fine scan mode is entered to determine the coordinate of the touch object (S15, S16). If the touch object does not exist, the sleep mode is entered (S17) and then determining if the period of the sleep mode has reached an estimated time (S171). If the period of the sleep mode has reached the estimated time, then return to the step S13;

The first baseline and the first threshold is adjusted by the adder-subtractor 34A. When the first baseline is adjusted (S191, S192), the adjusted first baseline is stored back to the first register 311A of the memory 31A in the detecting circuit 30A, When the first threshold is adjusted (S20), then the adjusted first threshold is stored back to the second register 312A of the memory 31A in the detecting circuit 30A.

By setting the forgoing detecting circuit 30A, the first sensing signals are received and the first sensing signals are compared with the first threshold by the ADC and controller to reduce the activity of the controller in the cursory scan mode and further reduce the electricity cost in further in the cursory scan mode.

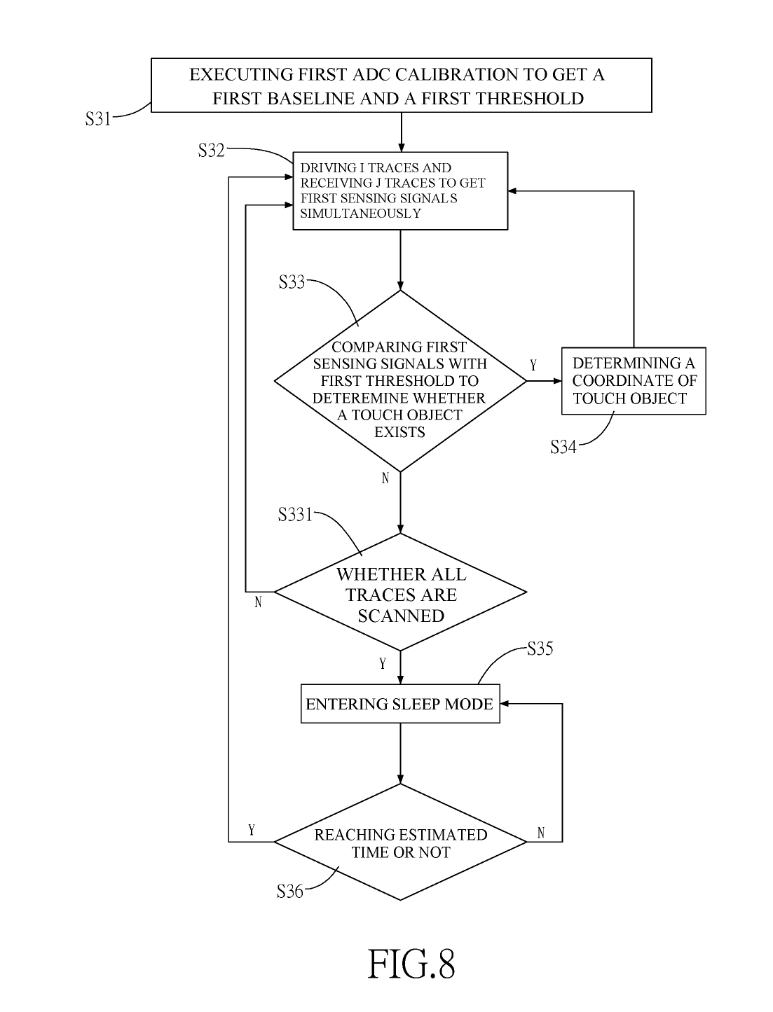

With reference of FIG. 8, a third embodiment of the scan method in accordance with the present invention has following steps:

Executing the first ADC calibration (S31): The first ADC calibration is executed to acquire the first baseline and the first threshold is set based on the first baseline;

Acquiring the first sensing signal (S32): The i traces are driven and the sensing signals of the j traces are received simultaneously;

Determining whether touch object exists (S33): The first sensing signals are compared with the first threshold to determine whether touch object exists;

Calculating the coordinate of the touch object (S34): if the touch object do exist, the coordinate of the touch object is determined and return to the steps of acquiring the first sensing signal (S32);

Determining if all the traces has scanned (S331): Whether all of the default traces has scanned or not are determined. If not all of the default traces are scanned, return back to the step (S32). If all the default traces has scanned, then the step (S35) is entered. The default traces may be all of the traces of the touch panel, or some of the traces of the touch panel which covered all of the area of the touch panel. Taking touch panel with twenty-four traces as an example, the default traces could be total twenty-four traces, or even number or odd number of the twenty-four traces;

Entering the sleep mode: The sleep mode is entered if no touch object exists. If the period of the sleep mode has reached the second estimated time (S36), then return to the step S32.

By the forgoing scan method, the sensing value can be enlarged efficiently and the touch object can still be detected when touch object is with lower sensing signal.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A scan method for a touch panel comprising steps of:
executing a first Analog-to-Digital Converter calibration (ADC calibration) for a cursory scan mode to get a first baseline and setting a first threshold based on the first baseline;
executing a second ADC calibration for a fine scan mode to get a second baseline, and setting a second threshold based on the second baseline;
entering in the cursory mode or the fine scan mode;
in the cursory mode, driving i traces and receiving multiple first sensing signals of j traces simultaneously and comparing the first sensing signals with the first threshold to determine whether at least one touch object exists; if the at least one touch object exists, then entering the fine scan mode, wherein “i” and “j” are positive integers that are bigger than one;
in the fine scan mode, driving multiple first groups of the traces in sequence, wherein each first group of the traces includes k traces; receiving multiple second sensing signals from multiple second groups of the traces, wherein each second group of the traces includes h traces; and determining a coordinate of each one of the at least one touch object by the second sensing signals and the second threshold, “k” is a positive integer that is smaller than “i” but is bigger than one, and “h” is a positive integer that is bigger than or equal to one.

2. The scan method for a touch panel as claimed in claim 1, wherein the fine scan mode has steps of:
acquiring the second sensing signals and determining whether at least touch object exists by comparing the second sensing signals with the second threshold;
if the at least one touch object exists, then further determining the coordinate of each one of the at least one touch object and reporting the coordinate of each one of the at least one touch object; and
then back to the step of driving multiple first groups of traces.

3. The scan method for a touch panel as claimed in claim 2, wherein
the k traces of the first groups of the traces and the h traces of the second groups of the traces are the same traces;
when the second ADC calibration is executed under self-capacitance scanning, the k traces of the first groups of the traces is driven and the first sensing signals of the k traces of the first groups of the traces are received; and
under self-capacitance scanning, the k traces are driven in sequence and the second sensing signals of the k traces of corresponding second groups of the traces are received until receiving the second sensing signals of all of the traces.

4. The scan method for a touch panel as claimed in claim 3, wherein “k” is equal to one.

5. The scan method for a touch panel as claimed in claim 3, wherein “k” is bigger than one and when the second sensing signals of each second group of the traces are received in the fine scan mode, the second sensing signals of each second group of the traces are received in a driving sequence, whereby the second sensing signals of the k traces in each second group of the traces are received simultaneously.

6. The scan method for a touch panel as claimed in claim 2, wherein
the traces of the touch panel include multiple first-axis traces and multiple second-axis traces, the k traces of the first groups of the traces are the first-axis traces and h traces of the second groups of the traces are the second-axis traces;
when the second ADC calibration is executed under mutual-capacitance scanning, the k traces of the first groups of the traces are driven and the second sensing signals of the h traces of the second groups of the traces are received;
in the fine scan mode under mutual-capacitance scanning, the k traces of the first groups of the first-axis traces are driven in sequence and the k traces of each first group of the first-axis traces are driven at each time and the second sensing signals of a corresponding second group of the second-axis traces are received in sequence until all of the first-axis traces are driven.

7. The scan method for a touch panel as claimed in claim 6, wherein “h” is equal to one and when the second sensing signals of the corresponding second group of the second-axis traces are received, the second sensing signals of all second-axis traces are received in sequence.

8. The scan method for a touch panel as claimed in claim 6, wherein “h” is bigger than one and the second sensing signals of the h traces of each second group are received simultaneously in the fine scan mode.

9. The scan method for a touch panel as claimed in claim 1, wherein
the i traces and the j traces are the same traces;
when the first ADC calibration is executed under self-capacitance scanning, the i traces are driven simultaneously and the first sensing signals of the i traces are received simultaneously; and
in the cursory scan mode under self-capacitance scanning, the i traces are driven simultaneously and the first sensing signals of the i traces are received simultaneously.

10. The scan method for a touch panel as claimed in claim 1, wherein
the traces of touch panels include multiple first-axis traces and multiple second-axis traces;
the i traces are included in the first-axis traces and the j traces are included in the second-axis traces;
when the first ADC calibration is executed under mutual-capacitance scanning, the i traces are driven simultaneously and the first sensing signals of the j traces are received simultaneously; and
in the cursory scan mode under mutual-capacitance scanning, the i traces are driven simultaneously and the first sensing signals of the j traces are received simultaneously.

11. The scan method for a touch panel as claimed in claim 1 further comprising steps of:
comparing the first sensing signals with the first baseline when no touch object exists in the cursory scan mode; and
adjusting the first baseline or the first threshold based on the comparison result.

12. The scan method for a touch panel as claimed in claim 11 further comprising steps of:
determining whether the first baseline or the first threshold is adjusted before acquiring the second sensing signals in the fine scan mode; and
if the first baseline or the first threshold has been adjusted, adjusting the second baseline or the second threshold based on the adjusted first baseline or the adjusted first threshold.

13. A scan method for a touch panel comprising steps of:
executing a first Analog-to-Digital Converter calibration (ADC calibration) to get a first baseline and setting a first threshold based on the first baseline;
driving i traces and receiving multiple first sensing signals of j traces simultaneously, wherein “i” and “j” are positive integers that are bigger than one;
comparing the first sensing signals with the first threshold to determine whether at least one touch object exists;
if the at least one touch object do exist, determining a coordinate of each one of the at least one touch object and going back to the step of driving the i traces.

14. The scan method for a touch panel as claimed in claim 13, wherein
the i traces and the j traces are the same traces;
when the first ADC calibration is executed under self-capacitance scanning, the i traces are driven simultaneously and the first sensing signals of the i traces are received simultaneously; and
when the i traces are driven and received under self-capacitance scanning, the i traces are driven simultaneously and the first sensing signal of the i traces are received simultaneously.

15. The scan method for a touch panel as claimed in claim 13, wherein
the traces of touch panels include multiple first-axis traces and multiple second-axis traces;
the i traces and the j traces are the different traces, the i traces are included in the first-axis traces and the j traces are included in the second-axis traces;
when the first ADC calibration is executed under mutual-capacitance scanning, the i traces are driven simultaneously and the first sensing signal of the j traces are received simultaneously; and
when the i traces are driven and the first sensing signal of the j traces are received under mutual-capacitance scanning, the i traces are driven simultaneously and the first sensing signal of the j traces are received simultaneously.

16. A touch device comprising:
a touch panel having p traces;
a controller connecting to the touch panel and having
a driving unit;
a receiving unit having at least one sub-receiving unit to receive sensing signals simultaneously;
a memory unit saving a first ADC calibration, a second ADC calibration, a cursory scan mode and a fine scan mode; and
a processor executing following steps when started:
controlling the driving unit to execute the first ADC calibration for the cursory scan mode, obtaining a first baseline by the receiving unit, setting a first threshold based on the first baseline, and storing the first baseline and the first threshold in the memory unit;
controlling the driving unit to execute the second ADC calibration for the fine scan mode, obtaining a second baseline by the receiving unit, setting a second threshold based on the second baseline, and storing the second baseline and the second threshold in the memory unit.
entering in the cursory mode or the fine scan mode:
receiving multiple first sensing signals of j traces simultaneously by the at least one sub-receiving unit in the cursory mode and determining whether at least one touch object exists by the first sensing signals, wherein “j” is a positive integer that is bigger than one;
receiving at least one second sensing signal of h traces simultaneously by the at least one sub-receiving unit in the fine scan mode and determining a coordinate of each one of the at least one touch object by the at least one second sensing signal, wherein “h” is a positive integer that is bigger than or equal to one.

17. The touch device as claimed in claim 16, wherein
in the cursory scan mode, the processor executes following steps:
controlling the driving unit by the processor to drive i traces simultaneously, wherein “i” is a positive integer that is bigger than one;
receiving the first sensing signals of the j traces simultaneously by the at least one sub-receiving unit to acquire the first sensing signals;
comparing the first sensing signals with the first threshold to determine whether the at least one touch object exists; and
if the at least one touch object exists, then entering the fine scan mode; and
in the fine scan mode, the processor executes following steps:
controlling the driving unit by the processor to drive multiple first groups of the traces in sequence, wherein each first group of the traces includes k traces;
receiving the second sensing signals from multiple second groups of the traces by the at least one sub-receiving unit, wherein each second group of the traces includes h traces; and
determining a coordinate of each one of the at least one touch object by the second sensing signals and the second threshold, wherein “k” is a positive integer that is smaller than “i” but is bigger than one.

18. The touch device as claimed in claim 17, wherein
the k traces of the first groups of the traces and the h traces of the second groups of the traces are the same traces;
when the processor executes the second ADC calibration under self-capacitance scanning, the driving unit drives the k traces of the first groups of the traces, and the second sensing signals of the k traces of the first groups of the traces are received by the at least one sub-receiving unit; and
when the processor executes the fine scan mode under self-capacitance scanning, the driving unit drives the k traces of the first groups of the traces and the second sensing signals of the k traces of the corresponding second groups of the traces are received by the at least one sub-receiving unit until the second sensing signals of all of the traces are received.

19. The touch device as claimed in claim 17, wherein
the p traces of touch panel include multiple first-axis traces and multiple second-axis traces;
the k traces of the first groups of the traces are the first-axis traces and the h traces of the second groups of the traces are the second-axis traces;
when the processor executes the second ADC calibration under mutual-capacitance scanning, the driving unit drives the k traces of the first groups of the traces, and the second sensing signals of the h traces of the second groups of the traces are received by the at least one sub-receiving unit; and
when the processor executes the fine scan mode under mutual-capacitance scanning, the driving unit drives the k traces of the first groups of the first-axis traces in sequence wherein the k traces of each first group of the first-axis traces are driven in sequence at each time, and the second sensing signals of the corresponding second group of the second-axis traces are received in sequence by the at least one sub-receiving unit until all of the first-axis traces are driven.

20. The touch device as claimed in claim 17, wherein
the i traces and the j traces are the same traces and the receiving unit has one sub-receiving unit;
when the processor executes the first ADC calibration under self-capacitance scanning, the driving unit drives the i traces simultaneously, the first sensing signals of the i traces are received simultaneously by the sub-receiving unit; and
when the processor executes the cursory scan mode under self-capacitance scanning, the i traces are driven simultaneously and the first sensing signals of the i traces are received simultaneously by the sub-receiving unit.

21. The touch device as claimed in claim 17, wherein
the p traces of touch panel include multiple first-axis traces and multiple second-axis trace;
the i traces are included in the first-axis traces, the j traces are included in the second-axis traces and the receiving unit has one sub-receiving unit:
when the processor executes the first ADC calibration under mutual-capacitance scanning, the driving unit drives the i traces simultaneously, and the first sensing signals of the j traces are received simultaneously by the sub-receiving unit; and
when the processor executes the cursory scan mode under mutual-capacitance scanning, the driving unit drives the i traces simultaneously and the first sensing signals of the j traces are received simultaneously by the sub-receiving unit.

22. The touch device as claimed in claim 16, wherein the processor further executes following steps:
comparing the first sensing signals with the first baseline when no touch object exists in the cursory scan mode; and
adjusting the first baseline or the first threshold based on the comparison result and storing the adjusted first baseline or the adjusted first threshold back to the memory unit.

23. A touch device comprising:
a touch panel having p traces;
a controller connecting to the touch panel and having
a driving unit;
a receiving unit having at least one sub-receiving unit to receive sensing signals simultaneously; and
a processor; and
a detecting circuit connecting to the touch panel and the controller and having
a memory having
a first register saving a first baseline; and
a second register saving a first threshold;
an ADC having an input connecting to the p traces of the touch panel to receive the sensing signals of the p traces simultaneously and to convert the sensing signals to corresponding sensing values; and
a comparator having
a first input connecting to an output of the ADC to acquire the sensing values;
a second input connecting to the second register of the memory to acquire the first threshold; and
an output of the comparator connecting to the processor,
wherein the comparator compares the sensing values with the first threshold to determine whether the processor should be waked up.

24. The touch device as claimed in claim 23, wherein
the controller have a memory unit saving a first ADC calibration, a second ADC calibration, a cursory scan mode and a fine scan mode; and
the processor execute following steps when started:
controlling the driving unit to execute the first ADC calibration, obtaining the first baseline for the cursory scan mode by the at least one sub-receiving unit, setting the first threshold based on the first baseline, and storing the first baseline and the first threshold into the first and second register of the memory unit; and
controlling the driving unit to execute the second ADC calibration, obtaining a second baseline for the fine scan mode by the at least one sub-receiving unit, setting a second threshold based on the second baseline, and storing the second baseline and the second threshold into the memory unit of the controller.

25. The touch device as claimed in claim 24, wherein
in the cursory mode, the processor executes following steps:
controlling the driving unit by the processor to drive i traces simultaneously;
controlling the ADC of the detecting circuit to receive multiple sensing signals of j traces simultaneously to obtain the first sensing signals;
comparing the first sensing signals with the first threshold by the comparator of the detecting circuit to determine whether at least one touch object exists; if the at least one touch object exists, then entering the fine scan mode, wherein “i” and “j” are positive integers that are bigger than one; and
in the fine scan mode, the processor executes following steps:
controlling the driving unit by the processor to drive multiple first groups of the traces in sequence, wherein each first group of the traces includes k traces;
controlling the at least one sub-receiving unit to receive multiple second sensing signals from multiple second groups of the traces, wherein each second group of the traces includes h traces; and
determining a coordinate of each one of the at least one touch object by the second sensing signals and the second threshold, wherein “k” is a positive integer that is smaller than “i” but is bigger than one, and “h” is a positive integer that is bigger than or equal to one.

26. The touch device as claimed in claim 25, wherein
the k traces of the first groups of the traces and the h traces of the second groups of the traces are the same traces:
when the processor executes the second ADC calibration under self-capacitance scanning, the driving unit drives the k traces of the first groups of the traces, and the second sensing signals of the k traces of the first groups of the traces are received by the at least one sub-receiving unit; and
when the processor executes the fine scan mode under self-capacitance scanning, the driving unit drives the k traces of the first groups of the traces in sequence and the second sensing signals of the k traces of corresponding second groups of the traces are received by the at least one sub-receiving unit until the second sensing signals of all of the traces are received.

27. The touch device as claimed in claim 25, wherein
the p traces of touch panel include multiple first-axis traces and multiple second-axis traces;
the k traces of the first groups of the traces are the first-axis traces and the h traces of the second groups of the traces are the second-axis traces;
when the processor executes the second ADC calibration under mutual-capacitance scanning, the driving unit drives the k traces of the first groups of the traces, and the second sensing signals of the h traces of the second groups of the traces are received by the at least one sub-receiving unit; and
when the processor executes in the fine scan mode under mutual-capacitance scanning, the driving unit drives the k traces of the first group of the first-axis traces in sequence wherein the k traces of the first group of the first-axis traces are driven in sequence at each time, and the second sensing signals of the corresponding second group of the second-axis traces are received in sequence by the at least one sub-receiving unit until all of the first-axis traces are driven.

28. The touch device as claimed in claim 25, wherein
the i traces and the j traces are the same traces;
when the processor executes the first ADC calibration under self-capacitance scanning, the driving unit drives the i traces simultaneously, the first sensing signals of the i traces are received simultaneously by the ADC; and
when the processor executes in the cursory scan mode under self-capacitance scanning, the driving unit drives the i traces simultaneously and the first sensing signals of the i traces are received simultaneously by the ADC.

29. The touch device as claimed in claim 25, wherein
the p traces of touch panel include multiple first-axis traces and multiple second-axis traces, the i traces are included in the first-axis traces the j traces are included in the second-axis traces;
when the processor executes the first ADC calibration under mutual-capacitance scanning, the driving unit drives the i traces simultaneously, and the first sensing signals of the j traces are received simultaneously by the ADC; and
when the processor executes the cursory scan mode under mutual-capacitance scanning, the driving unit drives the i traces simultaneously and the first sensing signals of the j traces are received simultaneously by the ADC.

30. The touch device as claimed in claim 24, wherein the processor further executes following steps:
comparing the first sensing signals with the first baseline by the processor when no touch object exists in the cursory scan mode; and
adjusting the first baseline or the first threshold based on the comparison result and storing the adjusted first baseline or the adjusted first threshold back to the first register or the second register of the memory unit of the detecting circuit.
